(19) United States
(12) Patent Application Publication
(10) Pub. No.: US 2007/0116028 A1
(43) Pub. Date: May 24, 2007

(54) RECORDING METHOD FOR OPTICAL DISC

(76) Inventor: Yung-Chih Hsu, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/562,485

(22) Filed: Nov. 22, 2006

(30) Foreign Application Priority Data
Nov. 23, 2005 (TW) 094141055

(51) Int. Cl. H04L 12/56

(52) U.S. Cl. 370/412; 370/401

(57) ABSTRACT

The invention provides a method for recording data packets to be recorded onto an optical disc via a buffer memory. The method, according to the invention, first, is to receive the data packets to be recorded and to store the received data packets in the buffer memory. Then, when the data packets stored in the buffer memory reach a threshold, the method, according to the invention, is to start recording the data packets stored in the buffer memory onto the optical disc, to encode the recorded data packet into a data stream, to store the data stream in the buffer memory to replace the original data packets, and finally to release the available space in the buffer memory.

### BACKGROUND OF THE INVENTION

1. Field of the Invention

The present invention relates to optical disc recording and, more particularly, to a recording method for optical discs with buffer handling and defect management.

2. Description of the Prior Art

Currently, the standard of the common format for CD-RW (Compact Disc Re-writable) is being discussed continually. The standard is called CD-MRW (CD-Mount Rainier rewritable), in which the recording area of an information-recording medium (e.g. optical disc) is divided into a plurality of areas, and the areas are provided with respective alternative areas. Among the areas, the areas in which user data is written are called Data Areas (DA), and the alternative areas are called Spare Areas (SA). Normally, when replacing a block of a DA in which an error occurs, the block is replaced by a block of a SA that immediately precedes the DA. This is a mechanism of defect management in the standard for CD MRW. The mechanism of defect management is also adopted in the disc standards of DVD-MRW, DVD-RAM, BD-R, BD-RE, and so on.

In the prior art, when a defect block is encountered in data recording, the writing process is suspended so as to perform a defect replacement process. Data in a buffer memory, which correspond to the defect block, are read for modifying the defect block and then are recorded into a corresponding SA. Accordingly, when there are many defect blocks in DA, frequent switches between the functions of reading and writing will affect the efficiency of the defect management process.

### SUMMARY OF THE INVENTION

Accordingly, a scope of the present invention provides a recording method for optical discs, such as optical discs in accordance with the standard for CD-MRW. According to the recording method of the present invention, data is accumulated in a buffer memory and then the received data is continuously recorded. Furthermore, when the buffer memory is used up, the method will perform a defect management process on the buffer memory, so that the frequency of interrupting the process of data recording by defect replacement is effectively decreased.

Another scope of the invention provides a higher usage of the buffer memory by compressing the recorded data into the buffer memory.

According to a preferred embodiment of the invention, in the recording method for optical disc, data packets to be recorded are first accumulated in a buffer memory; then, the data packets are recorded and verified onto the optical disc via the pick-up head of an optical disc drive. According to the recording method of the present invention, first, the data packets are received and then are stored into the buffer memory. Secondly, the recorded data packets are encoded into a data stream. Thirdly, the recorded data packets in the buffer memory are reorganized in accordance with a criterion. Finally, a defect verification process is performed on the recorded data packets on the optical disc based on the encoded data stream.

The advantage and spirit of the invention may be understood by the following recitations together with the appended drawings.

### BRIEF DESCRIPTION OF THE APPENDED DRAWINGS

FIG. 1A is a flow chart diagram showing the steps of the recording method according to a preferred embodiment of the invention.

FIG. 1B is a flow chart diagram showing the steps of the defect verification process according to the invention

FIG. 2 is a schematic diagram showing the recording method according to a preferred embodiment of the invention.

### DETAILED DESCRIPTION OF THE INVENTION

The present invention provides a recording method for optical discs, which also includes the method for buffer handling and defect management of the optical disc drive. According to the recording method of the present invention, data is accumulated in a buffer memory, and the received data is continuously recorded. Furthermore, when the buffer memory is used up, the method will perform a defect management process on the buffer memory, so that the frequency of interrupting the process of data recording by defect replacement is effectively decreased.

Another scope of the invention provides a higher usage of buffer memory by compressing the recorded data into the buffer memory. According to the recording method of a preferred embodiment of the invention, the received data in the buffer memory are compressed and encoded by the run-length encoding algorithm, so as to gain additional space for storing and recording data.

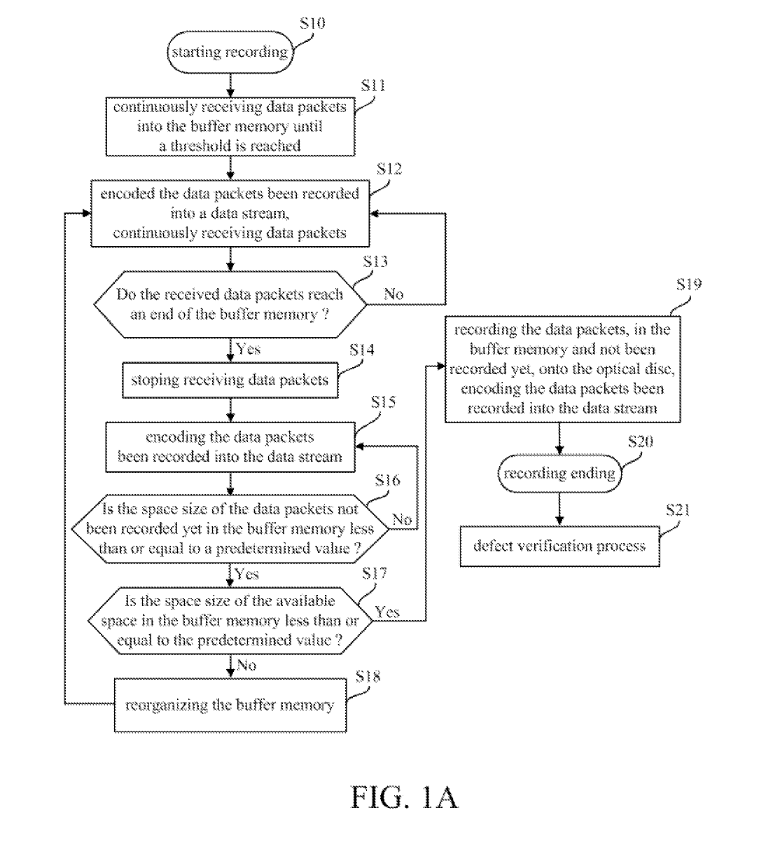

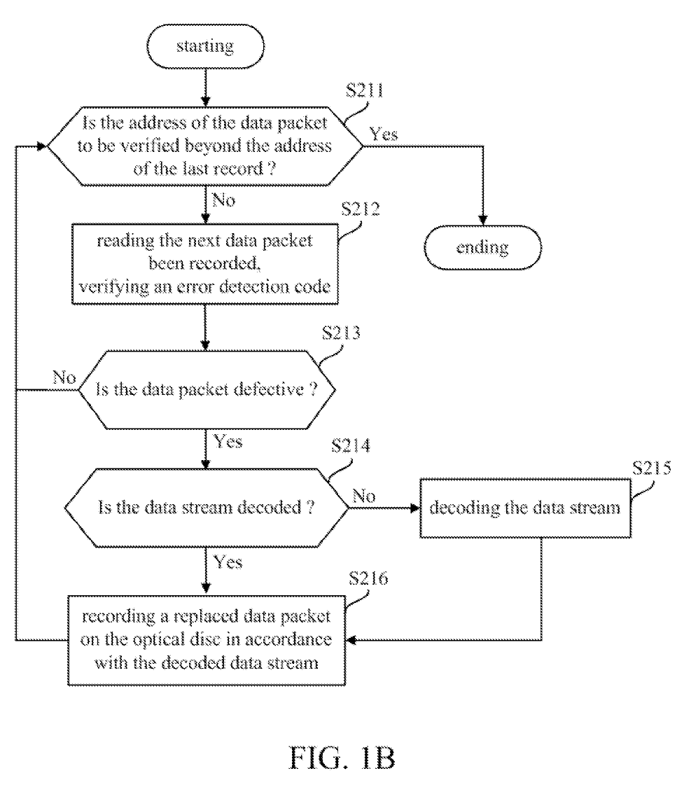

The following describes the steps of recording data onto an optical disc in detail according to the recording method of the present invention. FIG. 1A is a flow chart diagram of the steps of the recording method according to a preferred embodiment of the present invention. In the recording method of the present invention, data packets to be recorded are written onto an optical disc via an optical disc drive, wherein the data packet is a minimum writing unit of an optical disc. For example, in the standard of DVD, the size of the minimum writing unit in one writing is 16 blocks, about 32 k bytes. The optical disc drive includes a buffer memory, which is used to record the data packets to be recorded. The optical disc drive receives the data sequentially and accumulates the data packets to be recorded into the buffer memory; then, it reads the data packets in the buffer memory sequentially and records the data packets onto the optical disc via a pick-up head. In practical applications, the data packets to be recorded are provided by a host and are temporarily stored into the buffer memory of the optical disc drive.

According to the present invention, first, the recording method performs step S10, a recording process at the start. Secondly, to perform S11, the optical disc drive receives the data packets to be recorded into the buffer memory and does not record the data packets to be recorded directly onto the optical disc unless the data packets to be recorded stored in the buffer memory are accumulated to a threshold. The purpose of not immediately recording the data packets onto the optical disc is to avoid any occurrence of under-run error in the data in the buffer memory. When the accumulated data packets reach the threshold, the optical disc drive activates the data recording process, and the method is to perform step S12 at that time. The optical disc drive continuously receives data packets and also records the data packets in the buffer memory onto the optical disc. Then, the optical disc drive encodes the recorded data packets into a data stream; after that, the data stream is stored into the buffer memory from the start of the buffer memory to replace the original data packets, so as to release the space of the buffer memory where the recorded data packets are originally stored.

In a preferred embodiment, the encoding of the recorded data packets into a data stream can be implemented in a compression way. For example, the recorded data packets are compressed and encoded into the data stream by the run-length encoding algorithm, and the data stream hereby uses less buffer memory. Of course, other compression ways can also be applied in this process.

According to the recording method of the present invention, step S13 is performed next to verify whether the data packets accumulated in the buffer memory have reached the end of the buffer memory. If the verification of step S13 is negative, the recording of data in step S12 is executed continuously. If the verification of step S13 is positive, step S14 is performed because there is no more space at the end of the buffer memory for recording. The optical disc drive temporarily stops receiving data. The receiving of data packets will not be resumed until the buffer memory has finished reorganizing. Then, step S15 is performed. When the receiving of data packets stops, the optical disc drive continuously records the data packets in the buffer memory onto the optical disc and encodes the recorded data packets into the data stream. When the status of the buffer memory satisfies a criterion, the buffer memory is reorganized to allow the further receiving of data packets. The criterion and the buffer memory reorganization are described in detail in the following.

Step 16 is performed to verify whether the size of the data packets in the buffer memory, which have not been recorded yet, is less than or equal to a predetermined value (such as size of 5 data packets). If the verification of step S16 is negative, step S15 is repeated. Therefore, the data packets in the buffer memory are continuously recorded onto the optical disc, and the recorded data packets are encoded into the data stream to consume the data packets in the buffer memory. If the verification of step 16 is positive, step S17 is performed to verify whether the size of the available space in the buffer memory is less than or equal to the predetermined value. If the verification of step S17 is negative, step S18 is performed to reorganize the buffer memory. In a preferred embodiment, a lower boundary of the buffer memory is reset. The optical disc drive resumes to receive data packets, and the received data packets are accumulated, starting from the lower boundary. After resetting the lower boundary of the buffer memory, according to the present invention, the step flow of the recording method returns to step 12, and the above steps are repeated.

If the verification of step S17 is positive, it means that the buffer memory is used up, and the optical disc drive records the remaining data packets in the buffer memory, which have not been recorded yet, onto the optical disc and encodes them into the data stream (step S19). A recording process is completed at this point, and the data stream in the buffer memory is a compressed version of the recorded data packets in the current recording process (step S20). Before the optical disc drive releases the space of the buffer memory where the data stream is originally stored, the data stream is used to perform a defect verification process (step S21). The steps of the defect verification process are described in detail later.

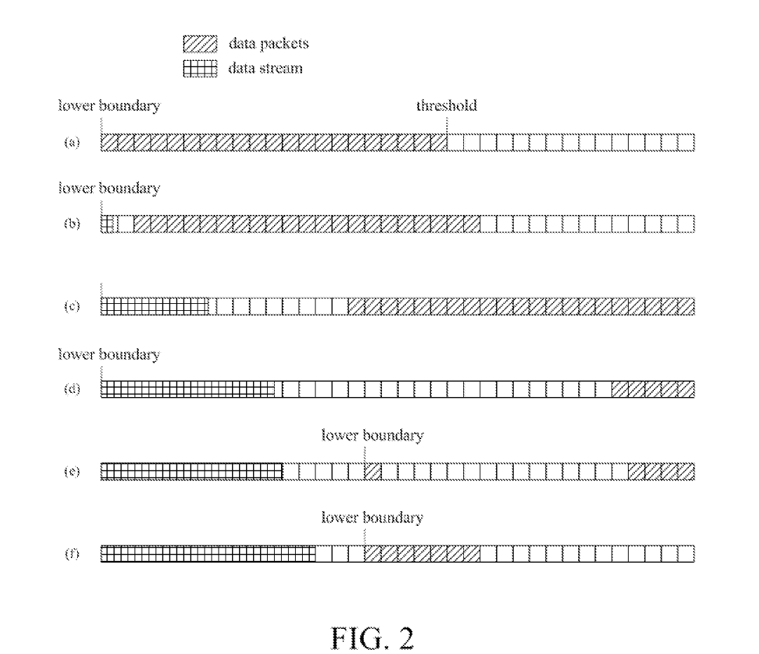

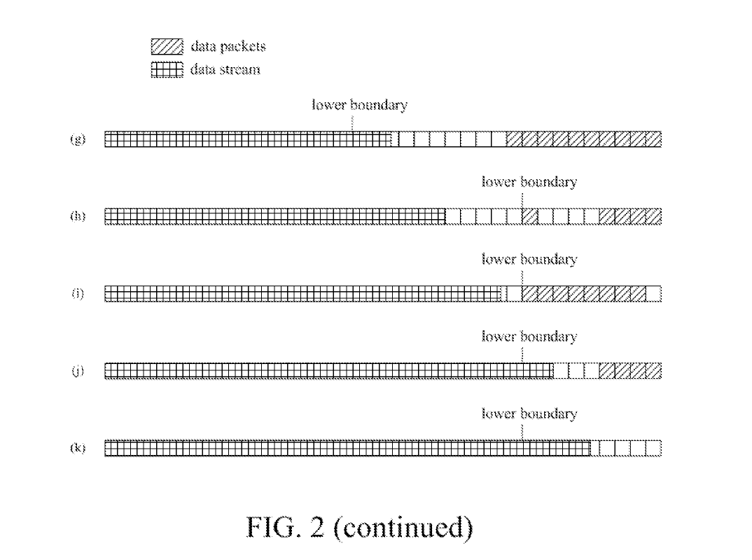

Please refer to FIG. 2. FIG. 2 is a schematic diagram showing the recording method according to a preferred embodiment of the invention. First, the recording process of the data packets, according to the present invention, is started. As shown in FIG. 2(a), initially, the lower boundary of the buffer memory is set as the start of the buffer memory. The optical disc drive starts to receive data packets and store the received data packets into the buffer memory, and the data packets are accumulated from the lower boundary until the accumulated data packets reach a threshold. As shown in FIG. 2(b), when the data packets accumulated in the buffer memory reach the threshold, the optical disc drive starts to record the data packets in the buffer memory onto the optical disc, starting from the lower boundary. At the same time, the optical disc drive continuously receives data packets and encodes the recorded data packets into the data stream; that is, the recorded data packets have been compressed and encoded into the data stream. Then, the data stream is stored in the buffer memory from the start of the buffer memory, as shown in FIG. 2(b). The operation shown in FIG. 2(b) is continuously executed until the data packets accumulated in the buffer memory reach the end of the buffer memory, as shown in FIG. 2(c). Because there is no more space at the end of the buffer memory for storing data packets, the optical disc drive stops receiving data packets. As shown in FIG. 2(d), after the receiving of data packets stops, the optical disc drive continuously records the data packets onto the optical disc and appends the recorded data packets to the end of the data stream. When the size of the data packets in the buffer memory, which have not been recorded yet, is less than or equal to a predetermined value (such as size of 5 data packets), and the size of the available space in the buffer memory is larger than the predetermined value, the buffer memory is reorganized to allow the further receiving of data packets.

As shown in FIG. 2(e), the lower boundary of the buffer memory is reset at the location of the predetermined value, away from the end of the data stream. The optical disc drive resumes to receive data packets, and the received data packets are accumulated, starting from the newly set lower boundary. The purpose of allowing blank space between the reset lower boundary and the end of the data stream is to avoid any conflict between the data stream and the data packets which have not been recorded yet. As shown in FIG. 2(f), the optical disc drive continuously receives data packets and records the data packets in the buffer memory onto the optical disc, and the optical disc drive continuously encodes and appends the recorded data packets to the end of the data stream. The above recording is executed continuously until the data packets accumulated in the buffer memory reach the end of the buffer memory again, as shown in FIG. 2(g), and then the optical disc drive temporarily stops receiving data packets. As shown in FIGS. 2(h) and (i), the optical disc drive continuously records the data packets in the buffer memory onto the optical disc and encodes and appends the recorded data packets to the end of the data stream. When the size of the data packets in the buffer memory, which have not been recorded yet, is less than or equal to the predetermined value (such as size of 5 data packets), and the size of the available space in the buffer memory is larger than the predetermined value, the lower boundary is reset again at the location of the predetermined value, away from the end of the data stream. The optical disc drive resumes to receive data packets and continues the above recording process. As shown in FIGS. 2(j) and (k), the data packets accumulated in the buffer memory reach the end of the buffer memory again. Because there is not enough space for reorganizing the buffer memory again, the receiving of data packets stops; the recording process is executed until all the remaining data packets in the buffer memory, which have not been recorded yet, are written onto the optical disc, and the recorded data packets are encoded and appended to the end of the data stream.

After the recording process is completed, the data stream in the buffer memory is a compressed version of the recorded data packets on the optical disc in the recording process. Before the optical disc drive releases the space of the buffer memory where the data stream is originally stored, the data stream is used to perform the defect verification process on the recorded data packets on the optical disc. Please refer to FIG. 1B. FIG. 1B is a flow chart diagram showing the steps of the defect verification process according to the invention. From the start address of the record data packets on the optical disc, the optical disc drive verifies the data packets recorded on the optical disc one by one. First, the optical disc drive determines whether the address of the current data packet is beyond the address of the last recorded data packet (step S211). If the determination is positive, the defect verification process is completed. On the other hand, step S212 is performed to read the next recorded data packet and to verify an error detection code. According to the verification of the error detection code, whether the data packet is defective is verified (step S213). If the data packet is defective, a defect replacement process must be performed to complete defect management on the optical disc. If the data packet is not defective, the step flow returns to step S211 for the next verification. Before the defect replacement process is preformed, whether the data stream is decoded is verified first (step S214). The data stream is the basis for defect replacement. If the data stream is not decoded yet, the decoding of the data stream is performed to get the original data which have been recorded on the optical disc (step S215). For the defective data packet, an additional replaced data packet is recorded onto the optical disc according to the decoded data stream, and then the step flow returns to step S211 for the next verification.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A recording method for recording data packets to be recorded onto an optical disc via a buffer memory, said method comprising the steps of:
(a) receiving the data packets to be recorded, and storing the received data packets into the buffer memory; and
(b) recording the data packets stored in the buffer memory onto the optical disc, encoding the recorded data packets into a data stream, storing the data stream in the buffer memory, and releasing the space of the buffer memory where the recorded data packets are originally stored.

2. The recording method of claim 1, wherein the encoding of the recorded data packets into the data stream is implemented in a compression way.

3. The recording method of claim 2, wherein the compression way is a Run-length encoding (RLE).

4. The recording method of claim 1, further comprising the step of:
(c) during step (b), reorganizing the buffer memory in accordance with a first criterion, continuously receiving the data packets to be recorded, and storing the received data packets into the buffer memory until a second criterion is satisfied.

5. The recording method of claim 1, further comprising the step of:
(d) based on the encoded data stream, performing a defect verification process on the recorded data packets on the optical disc.

6. The recording method of claim 4, wherein the first criterion is that the data packets accumulated in the buffer memory reach an end of the buffer memory, the size of the data packets in the buffer memory, which have not been recorded yet, is less than or equal to a predetermined value, and the size of the available space in the buffer memory is larger than the predetermined value.

7. The recording method of claim 6, wherein the reorganizing of the buffer memory is implemented by resetting a lower boundary of the buffer memory, and then the received data packets are stored into the buffer memory from the reset lower boundary.

8. The recording method of claim 7, wherein the second criterion is that the data packets accumulated in the buffer memory reach the end of the buffer memory, and the first criterion is not satisfied.

9. The recording method of claim 5, wherein the defect verification process comprises:
verifying an error detection code for the recorded data packets on the optical disc.

10. The recording method of claim 5, wherein step (d) further comprises:
if a defective data packet on the optical disc is verified, decoding the data stream, and performing a defect replacement process in accordance with the decoded data stream.

11. The recording method of claim 10, wherein the defect replacement process comprises:
for the defective data packet, recording a replaced data packet on the optical disc in accordance with the decoded data stream.
